(19) United States
(12) Patent Application Publication
(10) Pub. No.: US 2011/0173195 A1
(43) Pub. Date: Jul. 14, 2011

(54) Information processing apparatus, information processing method, and program

(75) Inventors: Mari Saito, Kanagawa (JP); Kei Tateno, Toyko (JP)

(73) Assignee: Sony Corporation, Tokyo (JP)

(21) Appl. No.: 12/930,313

(22) Filed: Jan. 3, 2011

(30) Foreign Application Priority Data
Jan. 12, 2010 (JP) P2010-003847

(51) Int. Cl. G06F 17/30

(52) U.S. Cl. 707/736; 707/E17.009

(57) ABSTRACT

Provided is an information processing apparatus including: analysis unit for determining association of attributes between items belonging to each different region, by analysis based on evaluation of respective items by users; setting unit for setting associated information which is information indicating the association determined by the analysis by the analysis unit to the respective items as metadata; acquisition unit for acquiring registration information in which attributes are registered corresponding to preferences of predetermined users; and recommendation unit for specifying, as recommendation items, the items which have association with attributes that are the attributes registered in the registration information acquired by the acquisition unit and have high dependence of the predetermined users, and which belong to a region different from a region to which the items of the attributes belong, based on the associated information.

### CROSS-REFERENCE TO RELATED APPLICATION

The present application claims priority from Japanese Patent Application No. JP 2010-003847 filed in the Japanese Patent Office on Jan. 12, 2010, the entire content of which is incorporated herein by reference.

### BACKGROUND OF THE INVENTION

1. Field of the Invention

The present invention relates to an information processing device, an information processing method, and a program, and more particularly, to an information processing device, an information processing method, and a program which is able to recommend an item matching preferences of a user across regions.

2. Description of the Related Art

In recent years, a Web service is emerging which recommends an item belonging to a region different from a reference item such as recommending a pot of a new product to a user as the user selects a cookbook.

Generally, this service recommending the item across regions is implemented on a rule base using predetermined recommendation rules or is implemented by collaborative filtering based on multiple user histories, such as a purchasing history.

As a problem of the latter, the service would not operate well without the history of many users. That is, it is necessary to clarify an association itself between the items traversing a plurality of regions using the history of many users.

On the other hand, when selecting content such as a television program or the like, there is a technique recommending, as associated content, an item in which the same keyword as the keyword set in the content is set as metadata. According to this technique, if a user has chosen a television program, a DVD (Digital Versatile Disc) on which a movie is recorded with the same person as the performer appearing on the television program is recommended.

Such a technique has a problem that the associated content may not be recommended if no keyword matches the content.

Accordingly, a method recommending the item in the form of traversing the region by determining the association between the items based on the user's evaluation is proposed (refer to Japanese Unexamined Patent Application Publication. No. 2009-140042).

### SUMMARY OF THE INVENTION

However, the method in Japanese Unexamined Patent Application Publication. No. 2009-140042 does not recommend the item taking into account the preference bias of the user.

In view of the above, it is desirable to recommend an item matching preferences of a user across regions.

The information processing apparatus according to an embodiment of the present invention includes analysis means for determining association of attributes of items belonging to each different region by analysis based on evaluation of respective items by users; setting means for setting associated information which is information indicating the association determined by the analysis by the analysis means to the respective items as metadata; acquisition means for acquiring registration information in which attributes are registered corresponding to preferences of predetermined users; and recommending means for specifying, as recommending items, the items which have association with attributes that are the attributes registered in the registration information acquired by the acquisition means and have high dependence of the predetermined users, and which belong to a region different from a region to which the items of the attributes belong, based on the associated information.

The information processing apparatus further includes average registration number calculation means for calculating an average registration number which is an average value of a registration number of the attributes registered in the registration information of a plurality of users; and comparison means for comparing the average registration number calculated by the average registration number calculation means with a user registration number which is a registration number of the attributes registered in the registration information of the predetermined users acquired by the acquisition means, wherein the recommendation means specifies, as the recommendation items, the items which have association with the attributes having a smaller user registration number compared to the average registration number in the registration information of the predetermined users, and which belong to a region different from a region to which the items of the attributes belong, based on the associated information.

The information processing apparatus further includes coincidence calculation means for calculating coincidence between the attributes registered in the registration information of the predetermined users acquired by the acquisition means and attributes of items to which the predetermined users previously have accessed, wherein the recommendation means specifies, as the recommendation items, the items which have association with the attributes having the coincidence greater than a predetermined value and which belong to a region different from a region to which the items of the attributes belong, based on the associated information.

The coincidence calculation means calculates coincidence between the attributes of the items to which the predetermined users previously have accessed and attributes extracted from expressions of the users when the predetermined users previously have accessed the items, and the recommendation means specifies, as the recommendation item, the items which have association with the attributes having the coincidence greater than a predetermined value and which belong to a region different from a region to which the items of the attributes belong, based on the associated information.

An information processing method according to an embodiment of the present invention includes the steps of: determining association of attributes between items belonging to each different region by analysis based on evaluation of respective items by users; setting associated information which is information indicating the association determined by the analysis by the analyzing step to the respective items as metadata; acquiring registration information in which the attributes are registered corresponding to preferences of predetermined users; and specifying, as recommendation items, the items which have association with attributes that are the attributes registered in the registration information acquired by the acquiring and have high dependence of the predetermined users, and which belong to a region different from a region to which the items of the attributes belong, based on the associated information.

The program according to an embodiment of the present invention causes a computer to execute processing, the processing including the steps of: determining association of attributes between items belonging to each different region by analysis based on evaluation of respective items by users; setting associated information which is information indicating the association determined by the analysis by the analyzing step to the respective items as metadata; acquiring registration information in which the attributes are registered corresponding to preferences of predetermined users; and specifying, as recommendation items, the items which have association with attributes that are the attributes registered in the registration information acquired by the acquiring and have high dependence of the predetermined users, and which belong to a region different from a region to which the items of the attributes belong, based on the associated information.

In an embodiment of the present invention, an association of attributes between items belonging to each different region is determined by analysis based on evaluation of respective items by users, associated information which is information indicating the association determined by the analysis is set to the respective items as metadata, registration information in which the attributes are registered corresponding to preferences of a predetermined users is acquired, and the items, which have association with attributes that are the attributes registered in the registration information acquired by the acquiring and have high dependence of the predetermined users, and which belong to a region different from a region to which the items of the attributes belong, are specified as recommendation items based on the associated information.

According to an embodiment of the present invention, it is possible to recommend the item matching preferences of a user across regions.

### BRIEF DESCRIPTION OF THE DRAWINGS

FIG. 1 is a block diagram illustrating a configuration example of a recommendation system related to an embodiment of the present invention.

FIG. 2 is a diagram illustrating an example of a mapping of genres.

FIG. 3 is a diagram illustrating an example of an association between the genres.

FIG. 4 is a diagram illustrating an example of an association between the genres.

FIG. 5 is a diagram illustrating an example of evaluation by the user.

FIG. 6 is a diagram illustrating an example of each dimensional value obtained by performing a dimensional compression.

FIG. 7 is a diagram illustrating an example of an association between the groups.

FIG. 8 is a diagram illustrating an example of an association of new items.

FIG. 9 is a flowchart explaining a metadata setting processing of a server.

FIG. 10 is a flowchart explaining for another metadata setting processing of a server.

FIG. 11 is a flowchart explaining for a recommendation processing of a server.

FIG. 12 is a block diagram illustrating another configuration example of a recommendation system.

FIG. 13 is a flowchart explaining for the recommendation processing of a server of FIG. 12.

FIG. 14 is a block diagram explaining a configuration example of hardware of a computer.

### DESCRIPTION OF THE PREFERRED EMBODIMENTS

Hereafter, the embodiments of the present invention will be described with reference to Figures.

### Configuration Example of Recommendation System

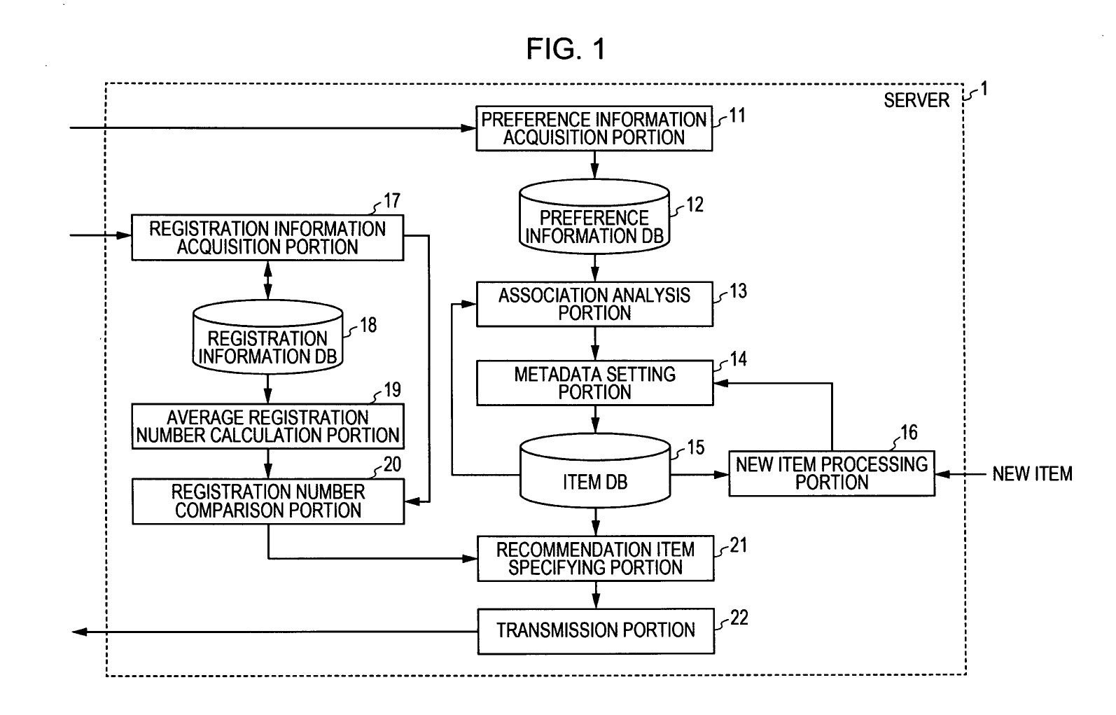

FIG. 1 is a block diagram illustrating a configuration example of a recommendation system related to an embodiment of the present invention.

As shown in FIG. 1, the recommendation system is implemented by a server 1.

The server 1 includes a preference information acquisition portion 11, a preference information database (DB) 12, an association analysis portion 13, a metadata setting portion 14, an item database (DB) 15, a new item processing portion 16, a registration information acquisition portion 17, a registration database (DB) 18, an average registration number calculation portion 19, a registration number comparison portion 20, a recommendation item specifying portion 21, and a transmission portion 22.

As will be described in detail below, in the server 1, an association between the items belonging to each different region can be obtained based on an evaluation of the item by the user, so that information representing the obtained association is set to respective items as a metadata.

Herein, the region includes a television program, a book, music, a game or the like. The item becomes each television program, each book such as a magazine, paperback book, music content for downloading, each piece of music such as a CD containing the music content, game content for downloading, each game such as a recording medium containing the game content.

The metadata which is set is used to specify the item recommended to the user. For example, the item of another region such as a book or music associated with the television program which becomes a reference is specified as the recommendation item with reference to a predetermined television program which is a user's preference. Information of the recommendation item is transmitted to a client that is used the user receiving the recommendation item.

That is, the server 1 is an apparatus performing the recommendation of an item in form of traversing the regions. A plurality of terminals such as a personal computer is connected to the server 1 via a network as the client.

The preference information acquisition portion 11 of the server 1 acquires the preference information representing the evaluation of the item by the user. For example, the user of a client inputs the evaluation of the item to the client after finishing the viewing of a television program, or after finishing the reading of a book or the like. In the client, the evaluation of the user and the preference information indicating which item was evaluated are generated and transmitted to the server 1. For the items which become a target of evaluation, a variety of metadata such as region, attribute, keyword, distributor are acquired by the server 1 by sampling.

Due to an operation by the manager of the server 1 using a mouse or remote controller or the like provided as an input device for the server 1, the preference information may be input.

The preference acquisition portion 11 acquires the preference information transmitted from the client or the inputted preference information and stores the acquired preference information in the preference information DB 12.

Using the preference information transmitted from the plurality of clients, in the server 1, the preference information indicating the evaluation of the items of the plurality of the regions is collected and stored in the preference information DB 12.

The association analysis portion 13 reads and analyzes the preference information from the preference information DB 12, and determines an association relating to the items, which is referred to specify another items on the basis of any item, between the attributes of the items or the like based on the evaluation by respective users.

Herein, the attributes of the items are for determining the category of the items in the regions to which the items belong, and specifically include a genre, a related person, an area, a price or the like.

For example, the genre as the attribute includes drama, news, educational, variety show in the television program region, and includes classics, nonfiction, practical, entertainment or the like in the book region. Also, the music region includes pop, classic, jazz, rock or the like, and the game region includes role-playing game, simulation game, sports game, action game or the like.

Further, for example, a related person as the attribute includes cast, staff or the like in the television program region, and includes an author, a translator or the like in the book region. Also, the music region includes a singer, a composer or the like, and the game region includes a programmer, a designer or the like.

Further, for example, the area as the attribute includes a broadcast area or the like in the television program region, and includes an author's native place or the like in the book region. Also, the music region includes a singer's native place or the like, and the game region includes a model area which became a model of a street during the game or the like.

Also, for example, the price as the attribute includes a high price and low price in each region of the book, the music, and the game, and there is no price attribute in the television program region.

As such, the items to categorize the items in the each region are given to the respective attributes, and the recommendation system of the present embodiment can recommend an item of another region by determining the association between the items of attributes in each region.

In addition, hereafter, the genre is described as the attribute as an example, but another attribute such as the related person, the area, or the price may be applicable.

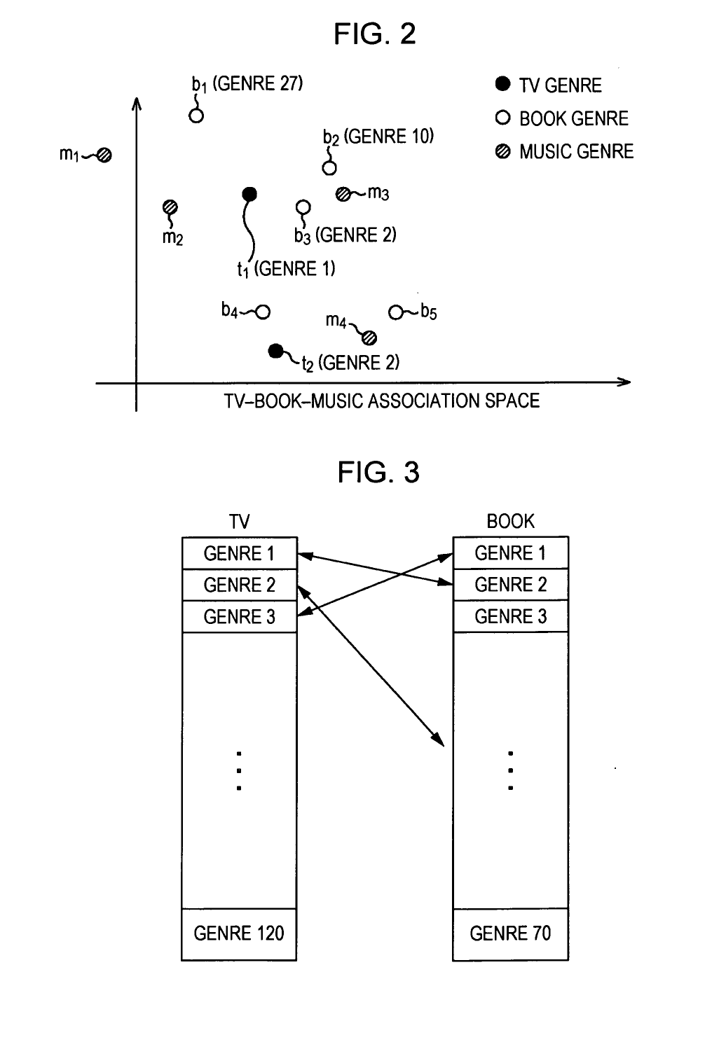

For example, as shown in FIG. 2, the association analysis portion 13 maps respective genres belonging to different regions in one space based on the evaluation by a user, and determines the association between the respective genres. The distance in the space between genres having the association becomes a closer distance since the evaluation is similar, and the distance in the space between the genres having no association becomes a farther distance since the evaluation is not similar.

The evaluation of the genres may be determined by the server 1 based on the evaluation of the items by a user belonging to respective genres, and the evaluation of the genres may be directly input by the user.

In the example of FIG. 2, points (t1 and t2) indicate the location of the television program (TV) in the genre space. Points (b1 to b5) indicate the location of the book in the genre space, and Points (m1 to m4) indicate the locations of the music in the genre space.

For example, the close distance between point t1 and point b3 indicates that the genre 1 of the television program which the location is indicated by point t1 and the genre 2 of the book which the location is indicated by point b3 have similarity in an evaluation of respective genres or an evaluation of items belonging to respective genres.

As shown in FIG. 3, the association analysis portion determines an association of the respective genres of another region on the basis of the respective genres of a specific region. In the example of FIG. 3, the genre 1 of the television program and the genre 2 of the book have the association, and the genre 3 of the television program and the genre 1 of the book have the association.

The association for the genre is determined by the association analysis portion 13 for between other regions as well as between the television program and the book.

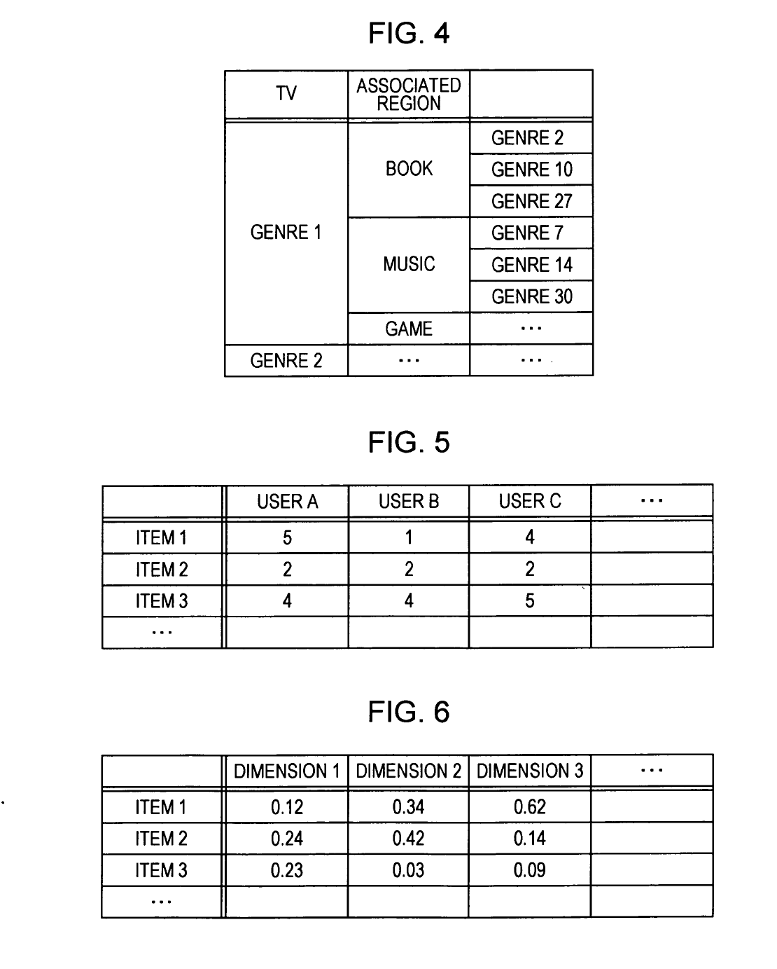

FIG. 4 is a diagram illustrating an example of an association between the genres.

In the example of FIG. 4, the genres having the association with the genre 1 of the television program are genres 2, 10 and 27 of the book, the genres 7, 14 and 30 of the music, and the predetermined genres of the game. In a similar manner to the genre 2 of the television program, the association with the genres of other regions is determined.

The association as described above can be determined from the item score and the genre score which can be obtained by performing principal component analysis, canonical correlation analysis, and categorical principal component analysis, for example, with the evaluation by the user as a target.

FIG. 5 is a diagram illustrating an example of evaluation by the user.

In the example of FIG. 5, the evaluation of the item 1 of a specific region by a user A has been evaluated as 5 of a 5 step evaluation, and the evaluation by a user B has been evaluated as 1. The evaluation by a user C has been evaluated as 4. Similarly, the evaluations of the item 2 by the users A to C have been evaluated both as 2. The evaluations of the item 3 by the user A and the user B have been evaluated as 4, and the evaluation by the user C has been evaluated as 5.

By performing the principal component analysis, for example, with the evaluation as the target as such, the patterns of similar evaluations are organized and the dimension compression is performed. In the example of FIG. 5, the evaluation of the items 1 to 3 by the user A and the user C have a similar pattern.

FIG. 6 is a diagram illustrating an example of each dimensional value obtained by performing a dimensional compression with the evaluation of FIG. 5 as the target.

In the example of FIG. 6, values of the dimension 1, 2 and 3 of the item 1 are 0.12, 0.34 and 0.62, respectively. By determining the value of each dimension by the principal component analysis and mapping each item or each genre in a space having each dimension as an axis, the distances between respective items and between genres are determined as described with reference to FIG. 2.

The number of analyzing dimensions may be any number, a number corresponding to one or more eigenvalues, a number just before a contribution ratio is significantly lowered, and a number above a certain cumulative contribution ratio.

The eigenvalue corresponds to a distribution of the principal component, and indicates the extent to which the principal component holds original information (variable). If the variance of an original variable is standardized to 1, the eigenvalue indicates how much of the original variable the principal component has. When the eigenvalue is less than or equal to 1, it is assumed that only information which is less or equal to the original variable exists, and it has no meaning as the principal component.

The contribution ratio indicates the percentage amount of all the information which the information indicated by any principal component occupies. The cumulative contribution ratio is the sum of the contribution ratio of each principal component in descending order, and indicates the percentage amount of information of the original information is indicated up to the principal component summing the contribution ratio (typically, up to the dimensions which indicates 70 to 80% are employed).

The canonical correlation analysis used in analyzing the evaluation by users is an analysis method for determining a weight coefficient such as the correlation between canonical variates is maximized by considering the variates (canonical variates) which sum and combine the weights (weight coefficients) to variables for each variable group. In this case, the weight variable is used to determine not the principal component score but the distance in the space.

A categorical principal component analysis is also a method to compile and analyze a pattern of similar evaluations in the same manner as the principal component analysis.

The evaluation of items of all K targeted regions may be compiled and analyzed, and only the evaluation of items of 2 regions among K regions are extracted and the relationship between the 2 regions is determined, so that by performing the number of the combination of these, the relationship between the items of all K regions may be analyzed.

In the former case, for example, when there are 3 regions of the television program, the book, and the music, all evaluation of items of respective regions is collectively analyzed and thus respective items are mapped in one space as shown FIG. 2. The determined principal component score of each item is used as a coordinate collectively indicating the locations on the collective space. In this case, since it is possible to map the items of all regions into one space, it is possible to determine the association between the items in one space.

In the latter case, for example, when there are 4 regions of the television program, the book, the music, and the movie, the evaluation of items is extracted by respective combination of the television program and the book, the television program and the music, the television program and the movie, the book and the music, the book and the movie, and the music and the movie, and the extracted respective evaluations are analyzed as the target.

The evaluation of each item of the television program and the evaluation of each item of the book are analyzed such that the association between the item of the television program and the item of the book is determined from the television program—book association space obtained by mapping each item, and the evaluation of each item of the television program and the evaluation of each item of the music are analyzed such that the association between the item of the television program and the item of the music is determined from the television program—music association space obtained by mapping each item.

Similarly, the association between the item of the television program and the item of the movie, the association between the item of the book and the item of the music, the association between the item of the book and the item of the movie, and the association between the item of the music and the item of the movie are each determined.

Also, if the association between the genres as shown in FIG. 3 is determined, the genre of respective regions may be classified into a predetermined number of groups, and the association between the groups may be determined.

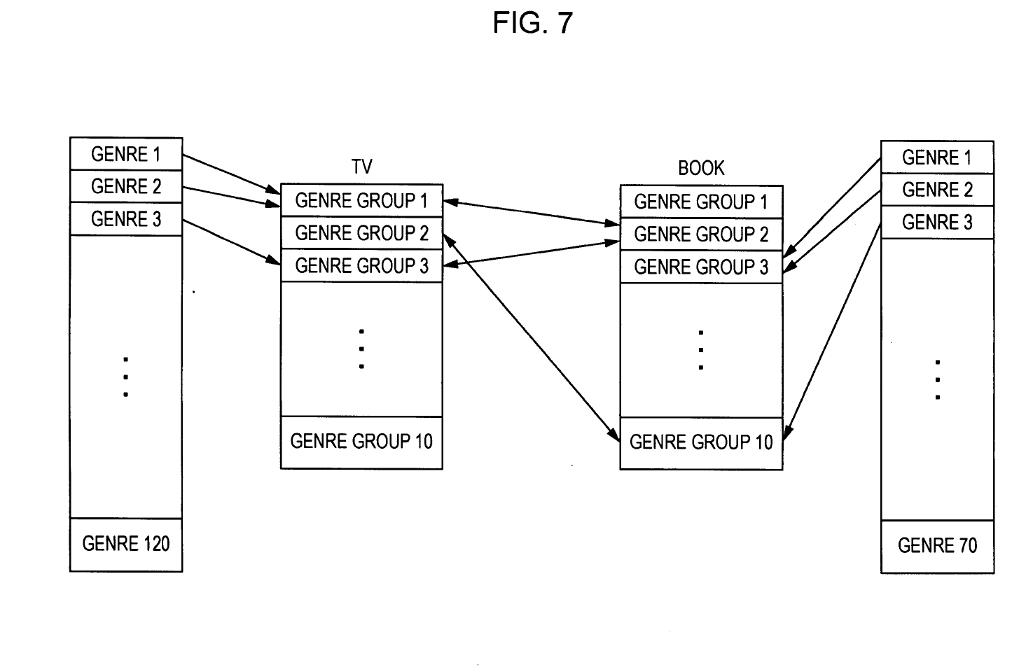

FIG. 7 is a diagram illustrating an example in a case of determining an association between the groups.

In FIG. 7, the genre 1 and genre 2 of the television program are classified as a genre group 1. Similarly, other genres of the television program are classified into predetermined genre groups.

On the other hand, the genre 1 and genre 2 of the book are classified as a genre group 3. Similarly, other genres of the book are classified into predetermined genre groups. For example, classification (clustering) of the genre group is specified based on a correlation value of evaluation of each genre.

Since the association between the genre groups classified as such can be determined by the principal component analysis or the canonical correlation analysis, as shown in FIG. 7, the genre group 2 of the book is specified as the genre group having the association with the genre group 1 of the television program. Also, the genre group 10 of the book is specified as the genre group having the association with the genre group 2 of the television program, and the genre group 2 of the book is specified as the genre group having the association with the genre group 3 of the television program.

The information indicating the association determined as such is supplied to the metadata setting portion 14 from the association analysis portion 13.

The metadata setting portion 14 sets the associated information which is the information indicating the association determined by the association analysis portion 13 as the metadata of respective items and stores it in the item DB 15. If the information indicating the association between the genres (between the attributes) is set to the item as the metadata, the information as shown in FIG. 4 indicating the genre (attribute) of another region having the association with the genre (attribute) of the item is set.

Also, the metadata setting portion 14 sets the associated information indicating the association determined by the new item processing portion 16 as the metadata of a new item, and stores it in the item DB 15.

When the information of the new item is input for which the evaluation by the user has not been obtained, the new item processing portion 16 specifies the item which is similar to the new item and for which the association has already been determined, based on the metadata other than the associated information. For example, the new item processing portion 16 determines the coincidence between the metadata of the new item and the metadata of respective items for which the association have already been determined and has been stored in the item DB 15, and specifies the item having the greatest coincidence among the items for which the association have already been determined as the item similar to the new item.

If the metadata used to determine the coincidence as such the genre is dense metadata, a cosine distance or inner product is determined, and the determined valued is used as the coincidence. Since there are a limited number of types of genre as the metadata, and if many items are sufficiently divided on the basis of genre, relatively many items of same genre are found, the genre can be said to be dense metadata.

On the other hand, if the metadata used to determine the coincidence such as a keyword or a sentence or the like is sparse metadata, after dimension-compressing by probabilistic latent semantic analysis (PLSA) or linear discriminant analysis (LDA) or the like, the distance is determined, and the determined distance is used as the coincidence. Since there are many types of keywords or sentences, and if many items are divided sufficiently based on the item which same keyword or sentence as the metadata is set, hardly any items with the same keyword or sentence as the metadata are found, the keyword or sentence can be said to be sparse metadata.

Also, if the association between the items, for which the evaluation by the user has been performed, is determined, the new item processing portion 16 maps the new item into a location in the same space as the items specified as those similar to the new item, and the item of another region having the association with the new item is determined. The new item processing portion 16 outputs the information of the determined item to the metadata setting portion 14.

That is, for the new item, the same associated information as the associated information set for the item for which the association has already been determined and which is similar to the new item is set as the metadata.

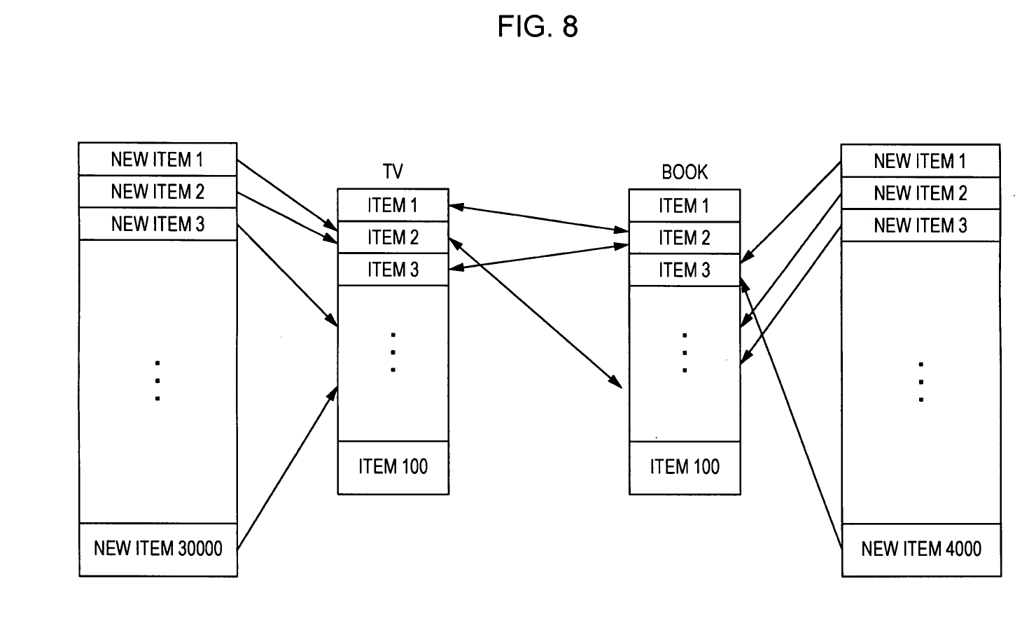

FIG. 8 is a diagram illustrating an example in a case of determining an association of new items.

FIG. 8 illustrates an example in a case of inputting information of new items 1 to 30000 which is the new items of the television program and information of new items 1 to 4000 which is the new items of the book.

In the example of FIG. 8, item 2 is an item of the television program for which the association with the item of another region has already been determined and which is similar to a new item 1 and a new item 2 of the television program. In this case, the associated information indicating the association with the item of the book having the association with an item 2 of the television program is set as a metadata in the new item 1 and the new item 2 of the television program.

On the other hand, an item 3 is an item of the book for which the association with the item of another region has already been determined and which is similar to a new item 1 and a new item 4000 of the book. In this case, the associated information indicating the association with the item of the television program having the association with an item 3 of the book is set as a metadata in the new item 1 and the new item 4000 of the book.

Returning to description of FIG. 1, the registration information acquisition portion 17 acquires the registration information which is information indicating the user preference in the recommendation system implemented by the server 1. For example, the user of the client inputs the preference of attributes for each region to the client when initially registering, changing registration content corresponding to the use of the recommendation system or the like. For the client, the identification information for identifying the user and the registration information indicating the user's preferred attributes are generated and transmitted to the server 1.

Specifically, for example, the user of the client selects (registers) the drama and the variety show which is the preferred genre for the television program as the region when initially registering. For the client, the identification information of the user and the registration information indicating the drama and the variety show which are the user's preference in the television program are generated and transmitted to server 1.

Also, the registration information may be input by a manager of the server 1 operating a mouse, a remote controller or the like provided as an input device to the server 1.

The registration information acquisition portion 17 acquires the registration information transmitted from the client or the input registration information, and stores the acquired registration information in the registration information DB 18.

By transmitting the registration information from a plurality of clients, in the server 1, the registration information for a plurality of users is collected and stored in the registration information DB 18.

Also, the registration information acquisition portion 17 acquires the registration information for the user (hereafter, referred to user registration information) from the registration information DB 18 according to requests for recommendation of items by the predetermined users in which the registration information is stored in the registration information DB 18, and supplies it to the registration number comparison portion 20.

The average registration number calculation portion 19 acquires the registration information of all of the users stored in the registration information DB 18 according to requests for item recommendation by the predetermined users, and calculates an average registration number which is the average value of the registration number of the attribute in the registration information of all of the users for each region.

More specifically, for example, the average registration number calculation portion 19 calculates the average registration number for each of the genre for the television program, the associated information, the region, and the cost in the registration information of all of the users stored in the registration information DB 18. Similarly, the average registration number calculation portion 19 calculates the average registration number for each of the attributes (the genre, the associated person, the region, and the cost) for another region such as the book, the music or the like.

The average registration number calculation portion 19 supplies the calculated average registration number to the registration number comparison portion 20.

The registration number comparison portion 20 compares the user registration number, which is the registration number for each of the attributes for each region in the user registration information from the registration information acquisition portion 17, with the average registration number from the average registration number calculation portion 19. The registration number comparison portion 20 determines the attribute having a smaller user registration number (small percentage) compared to the average registration number, and supplies the information indicating that attribute in the user registration information to the recommendation item specifying portion 21.

For example, in the user registration information, if the drama and the variety show which are the genre of the television program as the region are registered, the user registration number of the genre in the television program becomes 2. Herein, in the user registration information including this user registration number, in the case of having the smallest user registration number which is 2 compared to the average registration number for each of the attributes, the information indicating the drama and the variety show is supplied to the recommendation item specifying portion 21.

As such, if the user registration number of the predetermined attribute in the user registration information of any user is small compared to the average registration number of all of the users, the preference of the user is biased toward the certain genre (for example, drama and variety show) in the region (television program), and it can be said that there is high dependence on the attribute (genre).

The recommendation item specifying portion 21 specifies the item of the attribute of another region having association with the attribute having a high dependence from the user who wants to receive the recommendation as the recommendation item, based on the metadata of each item stored in the item DB 15.

For example, compared to the average registration value, if the user registration number of the genre in the television program is the lowest number, and the information indicating the drama and the variety show is supplied from the registration number comparison portion 20, the item of the genre of another region having association with any one of the drama and the variety show is specified as the recommendation item. Also, herein, in the item having association with the drama, and the item having association with the variety show, the item having a closer distance in the space shown in FIG. 2 is specified as the recommendation item.

More specifically, for example, in the case of setting the associated information such as classics and nonfiction which are the genre of the book, pop which is the genre of the music, simulation game which is the genre of the game or the like in the genre having association with the drama which is the genre of the television program, as the predetermined item metadata in the item DB 15, in the region of the book, the paperback book which the genre is classics having association with the drama is specified as the recommendation item, and in the region of the music, the CD which the genre is pop having association with the drama is specified as the recommendation item.

The recommendation item specifying portion 21 reads the information such as the distributor, the title of the recommendation item from the item DB 15, and outputs the read information to the transmission portion 22.

The transmission portion 22 transmits the information supplied from the recommendation item specifying portion 21 to the client being used by the user who wants to receive the recommendation via the network such as the Internet. In the client receiving the information transmitted from the transmission portion 22, the information of the recommendation item is provided to the user.

Also, in the examples above, while the genre as the attribute is exemplified, as other example, for example, the associated person may be applied.

At this time, in the respective items for the item DB 15, in addition to the associated information indicating the association between the genres determined by the association analysis portion 13, the associated information indicating the association between the associated people is set as the metadata. Also, the association between the associated persons is determined by the association analysis portion 13 similar to the association between the genres.

For example, the associated person having association with Taro who is in the cast of the television program sets, as the predetermined item metadata, the associated information such as Hanako and Jiro who are the author of the book, Saburo who is the singer of the music, Goro who is the programmer of the game.

Herein, in the user registration information of any user, if the user registration number of the cast of the television program is smaller compared to the average registration number of all users, the preference of the user is biased toward the certain cast (for example, Taro and Hanae) in that region (television program), and it can be said that there is high dependence on the attribute (cast).

In this case, the item of the associated person of another region having association with any of Taro and Hanae is specified as the recommendation item in the recommendation item specifying portion 21. More specifically, for example, in this region, the paperback book in which Hanako having association with Taro is the author is specified as the recommendation item, and in the music region, the CD in which Saburo having association with Taro is the singer is specified as the recommendation item.

Similarly, by using the associated information indicating the association between the region, or the associated information indication the association between the cost, the region having a high dependence from the user or the item having association with the cost is recommended traversing the regions.

Also, the associated information indicating the association between different attributes of each region can be used as the associated information in addition to the associated information indicating the association between the same attributes such as between the genres or between the associated people for each region. For example, the associated information indicating the association between the genre of the television program and the author of the book, or the associated information indicating the association between the genre of the television program and the cost of the book may be set as the item metadata in the item DB 15.

For example, the associated information that the attribute having association with the drama which is the genre of the television program is Jiro who is the author of the book is set as the predetermined item metadata. Herein, if the preference of any user is biased toward the drama in the television program, in the region of the book, the paperback book, which Jiro having association with the drama is the author, is specified as the recommendation item.

Also, for example, the associated information that the attribute having association with the variety show, which is the television program genre, and the cost of the book, which is low-cost, is set as the predetermined item metadata. Herein, if the preference of any user is biased toward the drama in the television program, in the region of the book, the paperback book (that is, low-cost paperback book) for which the cost is the low-cost having association with the drama is specified as the recommendation item.

Also, in the item for the item DB 15, the associated information indicating the association between all different attributes may be set without being limited to the combination of the attributes described above. Further, the association analysis portion 13 may determine this association between the different attributes.

Also, the combination of the different attributes in the associated information used in specifying the recommendation item of the recommendation item specifying portion 21 may be determined by detecting the bias of the attributes in each region based on the user registration information by the registration number comparison portion 20.

For example, in the user registration information of any user, if the preference is biased toward the drama in the television program and the preference is biased toward Jiro in the book, the registration number comparison portion 20 determines the drama (genre) of the television program and Jiro (author) in the book as the attributes having smaller user registration numbers. In the recommendation item specifying portion 21, the paperback book in which Jiro having association with the drama is the author is specified as the recommendation item based on the associated information indicating the association between the genre of the television program and the author of the book.

As such, the server 1 can recommend the item of various attributes to the user according to the preference of the user.

Next, a processing of the server 1 having the configurations above will be described.

### Metadata Setting Processing

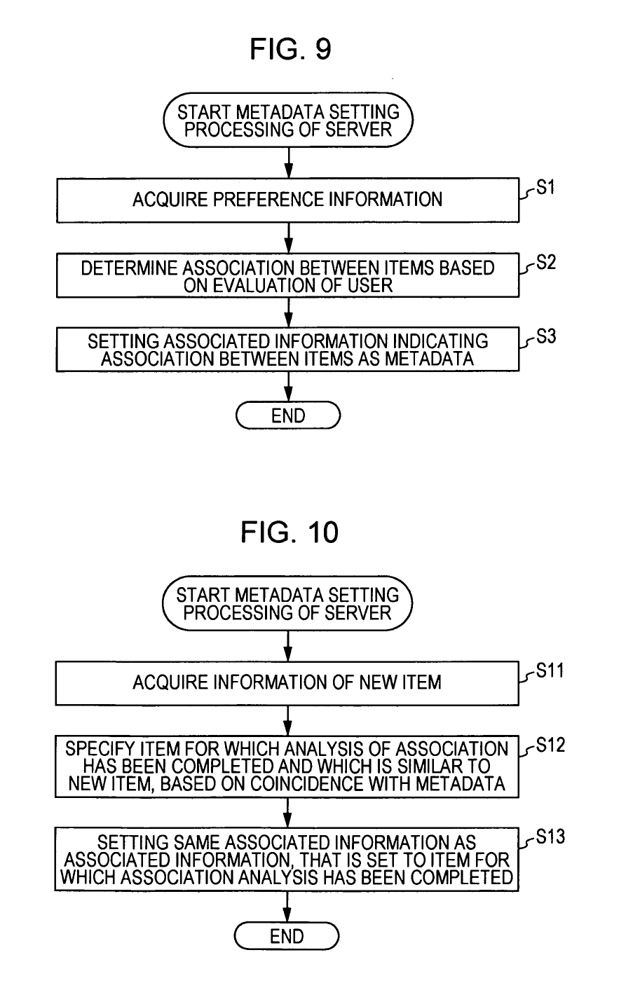

Initially, a processing where the server 1 sets the metadata will be described with reference to a flowchart of FIG. 9. Herein, the item that becomes a target for setting the associated information is not a new item but an item that has been evaluated by the user.

In the step S1, the preference information acquisition portion 11 acquires preference information indicating an evaluation of the item by a user, and stores the acquired preference information in the preference information DB 12.

In the step S2, the association analysis portion 13 reads and analyzes the preference information from the preference information DB 12, and determines the association between items based on the evaluation of respective users. Similarly, when determining the association between the genres, the analysis is performed based on the evaluation of respective genres determined from the evaluation by the user or the evaluation of respective genres input by the user.

In the step S3, the metadata setting portion 14 sets the associated information indicating the association determined by the association analysis portion 13 as metadata, and stores it in the item DB 15. Then, the processing is terminated.

Each time the preference information is acquired, by performing the processing above as a pre-processing before performing the recommendation of the item, the associated information for respective items of a plurality of regions is set.

### Metadata Setting Processing for New Item

Next, another processing of the server 1 of setting the metadata will be described with reference to a flow chart of FIG. 10. Herein, the item that becomes a target for setting the associated information is a new item.

In the step S11, the new item processing portion 16 acquires information of the new item for which the evaluation by the user has not been obtained. The acquired information also includes the metadata of the new item.

In the step S12, the new item processing portion 16 specifies the item for which the analysis of the association has been completed and which is similar to the new item, based on coincidence with the metadata. Also, the new item processing portion 16 maps the new item to a location in the same space as the specified item, and determines an item of another region having association with the new item.

In the step S13, the metadata setting portion 14 sets the same associated information as the associated information, that is set to the item for which the association analysis has been completed and which is similar to the new item, determined by the new item processing portion 16, as the metadata of new item, and stores it in the item DB 15. Then, the processing is terminated.

### Recommendation Processing of Item

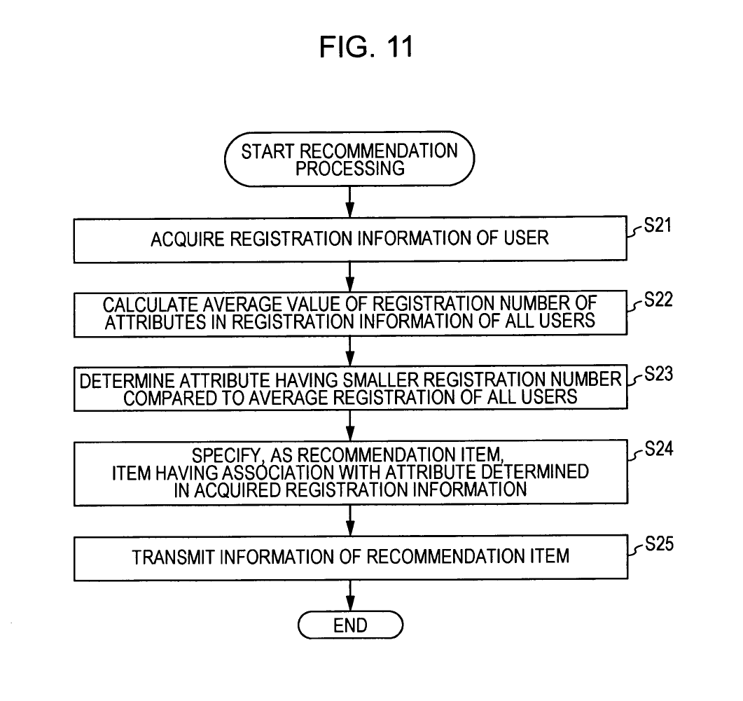

Next, recommendation processing of the server 1 of recommending the item will be described with reference to a flow chart of FIG. 11. For example, this processing is initiated when the user of the client requests the recommendation of the item.

In the step S21, the registration information acquisition portion 17 acquires the user registration information of the user requesting the recommendation of the item from the registration information DB 18, and supplies it to the registration number comparison portion 20.

In the step S22, the average registration number calculation portion 19 acquires the registration information of all of the users stored in the registration information DB 18, calculates the average value (average registration number) of the registration number of the attribute in the registration information of all of the users for each region, and supplies it to the registration number comparison portion 20.

In the step S23, the registration number comparison portion 20 compares the average registration number from the average registration number calculation portion 19 with the user registration information from the registration information acquisition portion 17, and determines the attribute having a smaller user registration number. The registration number comparison portion 20 supplies the information indicating the determined attributes to the recommendation item specifying portion 21 if the user registration number is smaller in the user registration information.

In the step S24, the recommendation item specifying portion 21 specifies, as the recommendation item, the attribute of the item of another region having association with any one of determined attributes if the user registration number is small compared to the average registration number in the user registration information indicated by the information from the registration number comparison portion 20, based on the item metadata stored in the item DB 15. The recommendation item specifying portion 21 outputs the information of the recommendation item to the transmission portion 22.

In the step S25, the transmission portion 22 transmits the information supplied from the recommendation item specifying portion 21 to the client, and terminates the processing.

The processing described above is performed each time the recommendation item is requested, and the recommendation item is sequentially provided to the user.

According the above processing, it is possible to determine the association between the attributes of the items belonging to different regions based on the evaluation of the items by the user. Also, it is possible to specify, as the recommendation item, the item of another region having association with the attribute having a high user's dependence. Accordingly, it is possible to recommend the item matching preferences of a user across regions. Herewith, in the recommendation system, since the item that is considered to be closer to the preference of the user is provided to the user, a purchase rate of the item or an access rate to the recommendation system can be improved.

In the above, while the attribute having a high dependence of the user is determined by comparing the registration information of the predetermined user with the registration information of all of the users, the attribute having a high dependence of user may be determined based on the registration information of user and the history of access to the item by the user.

### Another Configuration Example of Recommendation System

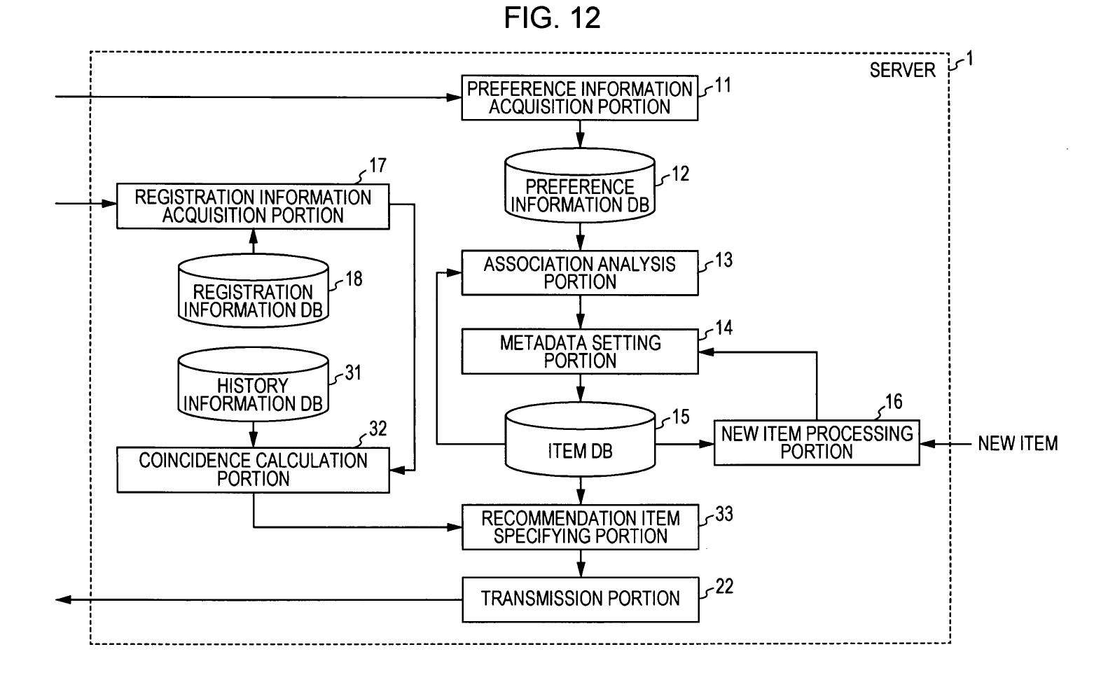

FIG. 12 is a block diagram illustrating another configuration example of a recommendation system. Among the configurations shown in FIG. 12, the same configurations as the configurations shown in FIG. 1 are shown with same numerals, and an overlapped description thereof is appropriately omitted.

The configuration of the server 1 shown in FIG. 12 is different from the configuration of the server 1 of FIG. 1 that a history information DB 31, a coincidence calculation portion 32, and a recommendation item specifying portion 33 instead of the average registration number calculation portion 19, the registration number comparison portion 20, and the recommendation item specifying portion 21 are provided.

The history information DB 31 stores the history information indicating the history of access by a user for the server 1 as the recommendation system. Herein, the access from the user indicates the access to the item by the user such as a reservation or purchase of the item by the user, or a browsing for the detailed description of the item. The history information is constituted to include identity information for identifying the user and the access information indicating the attribute as the item accessed by the user and the metadata thereof, and the access information is updated whenever the user has accessed the item.

For each of the attributes of each region, the coincidence calculation portion 32 calculates the coincidence between the attribute registered in the user registration information from the registration information acquisition 17 and the attribute of the item in the history information for the user who wants to receive a recommendation, stored in the history information DB 31, and supplies it together the information indicating the attribute thereof to the recommendation item specifying portion 33.

Herein, for example, the coincidence becomes a higher value as the number of the same genre in the genre of the television program registered in the user registration information, and the genre of the item (program) that the user was viewing increases in the history information. For example, if the drama and the variety show are registered as the genre of the region of the television program in the user registration information, once the viewing number of the program that the user was viewing is 5 in the drama, and 3 in the variety show, the coincidence of the drama has greater value than the coincidence of the variety show.

As such, if the coincidence between the attribute registered in the user registration information and the attribute of the item in the history information is high, the preference of the user is not changed since initial registering, and is biased toward the genre in the region (television program). Therefore, it can be said that there is high dependence on this attribute (genre).

The recommendation item specifying portion 33 specifies, as the recommendation item, the item of the attribute of another region having association with the attribute with greater coincidence than predetermined value in the coincidence from the coincidence calculation portion 32, based on the metadata of each item stored in the item DB 15.

For example, if the coincidence between the genre of the television program registered in the user registration information and the genre of the program that the user was viewing in the history information is greater than the predetermined value, the item of the genre of another region having association with the genre of the item having a great viewing number among the genres (for example, drama and variety show) having greater coincidence is specified as the recommendation item.

Also, in the above examples, while the genre as the attribute is exemplified, of course, other attributes may be applied.

The recommendation item specifying portion 33 reads the information such as the distributor, the title of the recommendation item from the item DB 15, and outputs the read information to the transmission portion 22.

### Recommendation Processing of Item

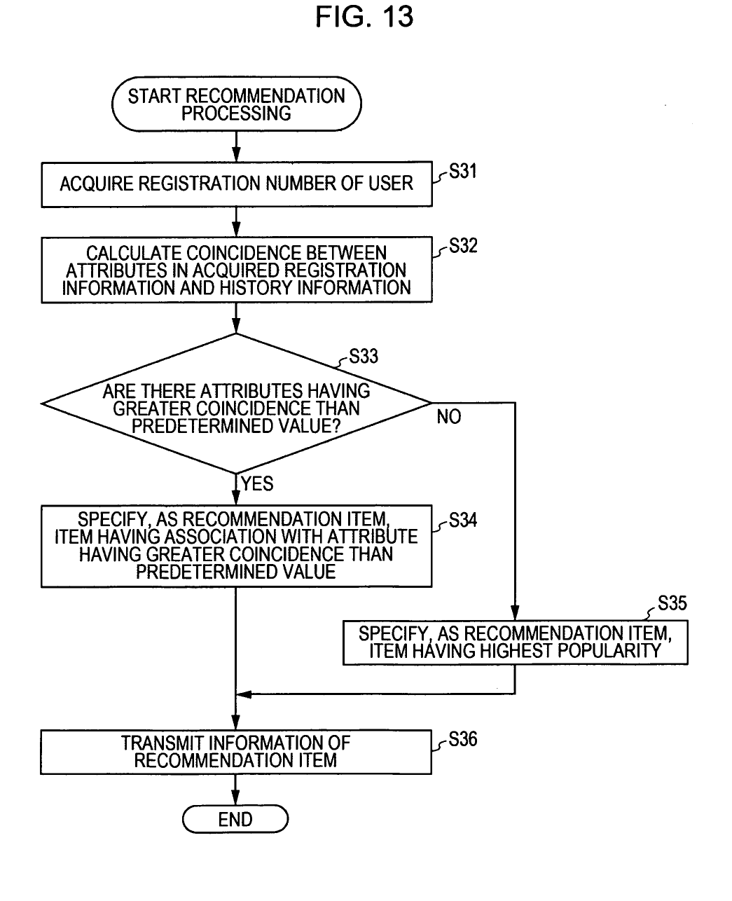

Next, the recommendation processing of the server 1 of FIG. 12 performing the recommendation of item will be described with reference to a flowchart of FIG. 13. For example, this processing is initiated when the user of client requests the recommendation of the item.

In the step S31, the registration information acquisition portion 17 acquires the user registration information for the user requesting the recommendation of the item from registration information DB 18, and supplies it to the coincidence calculation portion 32.

In the step S32, the coincidence calculation portion 32 calculates the coincidence between the attribute registered in the user registration information from the registration information acquisition portion 17 and the attribute of the item in the history information for the user requesting the recommendation of the item stored in the history information DB 31. The coincidence calculation portion 32 supplies the calculated coincidences to the recommendation item specifying portion 33.

In the step S33, the recommendation item specifying portion 33 determines whether or not the attribute having greater coincidence than the predetermined valued exists in the coincidence from the coincidence calculation portion 32.

In the step S33, if it is determined that the attribute having greater coincidence than the predetermined value exists, the processing proceeds to the step S34. In the step S34, the recommendation item specifying portion 33 specifies, as the recommendation item, the item of the attribute of another region having association with the attribute having greater coincidence (for example, the coincidence is highest) than the predetermined value, based on the metadata of each item stored in the item DB 15. The recommendation item specifying portion 33 outputs the information of the recommendation item to the transmission portion 22.

On the other hand, in the step S33, if it is determined that the attribute having greater coincidence than the predetermined value does not exist, the processing proceeds to the step S35. In the step S35, the recommendation item specifying portion 33, for example, specifies, as the recommendation item, the item having the highest popularity in each item stored in the item DB 15, and outputs the information of the recommendation item to the transmission portion 22.

In the step S36, the transmission portion 22 transmits the information supplied from the recommendation item specifying portion 33 to the client, and terminates the processing.

The processing described above is performed each time the recommendation of the item is requested, and the recommendation item for the user is sequentially provided.

Also, immediately after initial registration of the user in the recommendation system, since the history information of that user does not exist, in the step S34 described above, the item having the highest popularity in each item stored in the item DB 15 is specified as the recommendation item.

Also, in the step S34, while the item of the attribute of another region having association with the attribute having greater coincidence than the predetermined value is specified as the recommendation item, for example, the item having the highest popularity within the region of the attribute having greater coincidence than the predetermined value may be specified as the recommendation item.

According to the processing above, it is possible to determine the association between the attributes of the items belonging to different regions based on the evaluation of the items by the user. Also, it is possible to specify, as the recommendation item, the item of another region having association with the attribute having a high user's dependence. Accordingly, it is possible to recommend the item matching preferences of a user across regions. Herewith, in the recommendation system, since the item that is considered to be closer to the preference of the user is provided to the user, a purchase rate of the item or an access rate to the recommendation system can be improved.

In the above, while the attribute having a high dependence of the user has determined based on the attribute in the history information and the registration information of the user, by calculating the coincidence between the attribute as the item metadata in the history information and the keyword for the attribute extracted from the expressions (speech such as monolog, dialogue) representing the user during viewing of the item by the coincidence calculation portion 32, the attribute having a high dependence of the user may be determined. The coincidence in the embodiment of the invention can be determined as the distance between the attribute of the item in the history information and the keyword extracted from the expression representing the user.

Herewith, for example, even though the preference of the user changes from initially registering, it is possible to extract attributes according to the preference of the user in real time and to realize the recommendation of the item having association with the attribute thereof.

A series of processing described above may be executed by hardware, and may be executed by software. If the series of processing are executed by software, a program constituting the software is installed from a program recording medium on a computer embedded in dedicated hardware, or a general-purpose personal computer capable of executing various functions by installing various programs.

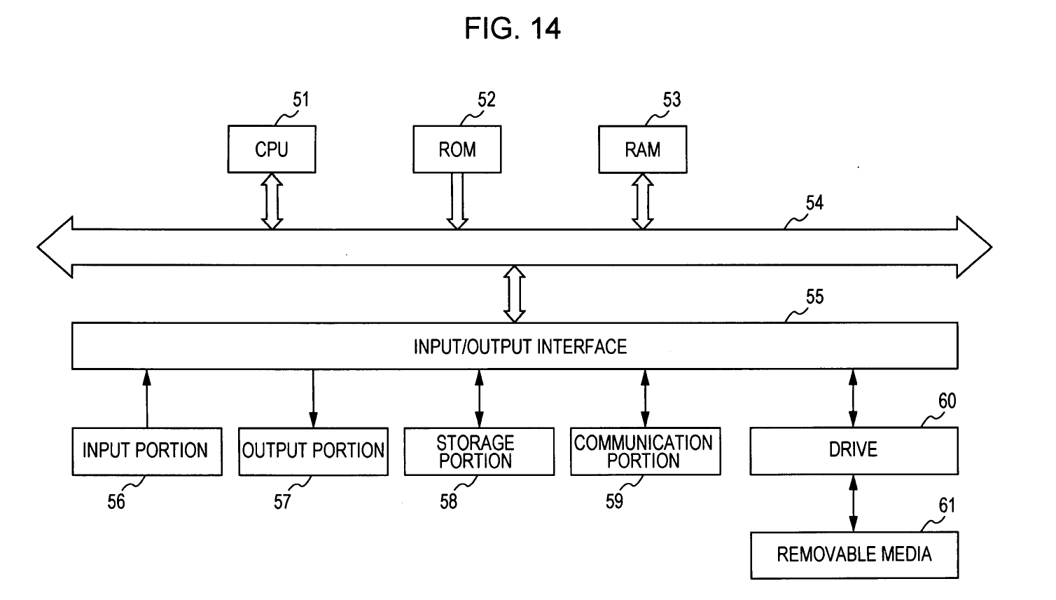

FIG. 14 is a block diagram illustrating a configuration example of computer hardware executing the series processing described above using a program.

A central Processing Unit (CPU) 51, a Read Only Memory (ROM) 52, and a Random Access Memory (RAM) 53 are inter-connected by a bus 54.

An input/output interface 55 is further connected to the bus 54. An input portion 56 such as a keyboard, a mouse, and a microphone, output portion 57 such as a display, a speaker, a storage portion 58 such as a hard disk or a non-volatile memory, a communication portion 59 such as a network interface, and a drive 60 for driving removable media 61 such as an optical disc or a semiconductor memory are connected to the input/output interface 55.

In the computer constituted as described above, CPU processes the above described series of processing by loading the program stored in the storage portion 58 to the RAM 53 and executing it through the input/output interface 55 and the bus 54, for example.

The program executed by the CPU 51 is provided, for example, by being recorded on the removable media 61, or through wire or wireless transmit medium such as local area network, internet, digital broadcast and is installed in the storage medium 58.

Also, the program executed by the computer may be a program for processing in a time series according to the order described in this specification, and may be program for processing in parallel or at a necessary timing such as when a request is made.

The embodiments of the invention are not intended to be limited to the embodiment described above, and various modifications are possible without departing from the principal of the invention.

It should be understood by those skilled in the art that various modifications, combinations, sub-combinations and alterations may occur depending on design requirements and other factors insofar as they are within the scope of the appended claims or the equivalents thereof.

What is claimed is:

1. An information processing apparatus comprising:
analysis means for determining association of attributes between items belonging to each different region, by analysis based on evaluation of respective items by users;
setting means for setting associated information which is information indicating the association determined by the analysis by the analysis means to the respective items as metadata;
acquisition means for acquiring registration information in which attributes are registered corresponding to preferences of predetermined users; and
recommendation means for specifying, as recommendation items, the items which have association with attributes that are the attributes registered in the registration information acquired by the acquisition means and have high dependence of the predetermined users, and which belong to a region different from a region to which the items of the attributes belong, based on the associated information.

2. The information processing apparatus according to claim 1, further comprising:
average registration number calculation means for calculating an average registration number which is an average value of a registration number of the attributes registered in the registration information of a plurality of the users; and
comparison means for comparing the average registration number calculated by the average registration number calculation means with a user registration number which is a registration number of the attributes registered in the registration information of the predetermined users acquired by the acquisition means,
wherein the recommendation means specifies, as the recommendation items, the items which have association with the attributes having a smaller user registration number compared to the average registration number in the registration information of the predetermined users, and which belong to a region different from a region to which the items of the attributes belong, based on the associated information.

3. The information processing apparatus according claim 1, further comprising:
coincidence calculation means for calculating coincidence between the attributes registered in the registration information of the predetermined users acquired by the acquisition means and attributes of items to which the predetermined users previously have accessed,
wherein the recommendation means specifies, as the recommendation items, the items which have association with the attributes having the coincidence greater than a predetermined value and which belong to a region different from a region to which the items of the attributes belong, based on the associated information.

4. The information processing apparatus according to claim 3:
wherein the coincidence calculation means calculates coincidence between the attributes of the items to which the predetermined users previously have accessed and attributes extracted from expressions of the users when the predetermined users previously have accessed the items, and
the recommendation means specifies, as the recommendation item, the items which have association with the attributes having the coincidence greater than a predetermined value and which belong to a region different from a region to which the items of the attributes belong, based on the associated information.

5. An information processing method, comprising the steps of:
determining association of attributes between items belonging to each different region by analysis based on evaluation of respective items by users;
setting associated information which is information indicating the association determined by the analysis by the analyzing step to the respective items as metadata;
acquiring registration information in which the attributes are registered corresponding to preferences of predetermined users; and
specifying, as recommendation items, the items which have association with attributes that are the attributes registered in the registration information acquired by the acquiring and have high dependence of the predetermined users, and which belong to a region different from a region to which the items of the attributes belong, based on the associated information.

6. A program for causing a computer to execute processing, the processing comprising the steps of:
determining association of attributes between items belonging to each different region by analysis based on evaluation of respective items by users;
setting associated information which is information indicating the association determined by the analysis by the analyzing step to the respective items as metadata;
acquiring registration information in which the attributes are registered corresponding to preferences of predetermined users; and
specifying, as recommendation items, the items which have association with attributes that are the attributes registered in the registration information acquired by the acquiring and have high dependence of the predetermined users, and which belong to a region different from a region to which the items of the attributes belong, based on the associated information.

7. An information processing apparatus comprising:
analysis unit for determining association of attributes between items belonging to each different region, by analysis based on evaluation of respective items by users;
setting unit for setting associated information which is information indicating the association determined by the analysis by the analysis unit to the respective items as metadata;
acquisition unit for acquiring registration information in which attributes are registered corresponding to preferences of predetermined users; and
recommendation unit for specifying, as recommendation items, the items which have association with attributes that are the attributes registered in the registration information acquired by the acquisition unit and have high dependence of the predetermined users, and which belong to a region different from a region to which the items of the attributes belong, based on the associated information.
